(19) United States
(12) Patent Application Publication
(10) Pub. No.: US 2012/0268359 A1
(43) Pub. Date: Oct. 25, 2012

(54) CONTROL OF ELECTRONIC DEVICE USING NERVE ANALYSIS

(75) Inventors: Ruxin Chen, Redwood City, CA (US); Ozlem Kalinli, Burlingame, CA (US); Richard L. Marks, Pleasanton, CA (US); Jeffrey R. Stafford, Redwood City, CA (US)

(73) Assignee: Sony Computer Entertainment Inc., Tokyo (JP)

(21) Appl. No.: 13/090,207

(22) Filed: Apr. 19, 2011

(51) Int. Cl. G06F 3/01

(52) U.S. Cl. 345/156

(57) ABSTRACT

An electronic device may be controlled using nerve analysis by measuring a nerve activity level for one or more body parts of a user of the device using one or more nerve sensors associated with the electronic device. A relationship can be determined between the user's one or more body parts and an intended interaction by the user with one or more components of the electronic device using each nerve activity level determined. A control input or reduced set of likely actions can be established for the electronic device based on the relationship determined.

### FIELD OF THE INVENTION

Embodiments of the present invention are directed to control interfaces for computer programs and more specifically to control interfaces that are controlled by nerve analysis.

### BACKGROUND OF THE INVENTION

There are a number of different control interfaces that may be used to provide input to a computer program. Examples of such interfaces include well-known interfaces such as a computer keyboard, mouse, or joystick controller. Such interfaces typically have analog or digital switches that provide electrical signals that can be mapped to specific commands or input signals that affect the execution of a computer program.

Recently, interfaces have been developed for use in conjunction with computer programs that rely on other types of input. There are interfaces based on microphones or microphone arrays, interfaces based on cameras or camera arrays, and interfaces based on touch. Microphone-based systems are used for speech recognition systems that try to supplant keyboard inputs with spoken inputs. Microphone array based systems can track sources of sound as well as interpret the sounds. Camera based interfaces attempt to replace joystick inputs with gestures and movements of a user or object held by a user. Touch based interfaces attempt to replace keyboards, mice, and joystick controllers as the primary input component for interacting with a computer program.

Different interfaces have different advantages and drawbacks. Keyboard interfaces are good for entering text, but less useful for entering directional commands. Joysticks and mice are good for entering directional commands and less useful for entering text. Camera-based interfaces are good for tracking objects in two-dimensions, but generally require some form of augmentation (e.g., use of two cameras or a single camera with echo-location) to track objects in three dimensions. Microphone-based interfaces are good for recognizing speech, but are less useful for tracking spatial orientation of objects. Touch-based interfaces provide more intuitive interaction with a computer program, but often experience latency issues as well as issues related to misinterpreting a user's intentions. It would be desirable to provide an interface that supplements some of the interfaces by analyzing additional characteristics of the user during interaction with the computer program.

A given user of a computer program may exhibit various activity levels in the nervous system during interaction with the computer program. These activity levels provide valuable information regarding a user's intent when interacting with the computer program. Such information may help supplement the functionality of those interfaces described above.

It is within this context that embodiments of the present invention arise.

### FIELD OF THE INVENTION

Embodiments of the present invention are related to a method for controlling a computer program running on an electronic device using nerve analysis.

### BRIEF DESCRIPTION OF THE DRAWINGS

FIG. 1 is a flow diagram illustrating a method for controlling a computer program running on an electronic device using nerve analysis according to an embodiment of the present invention.

FIG. 2 is a schematic diagram illustrating a component of an electronic device configured to measure nerve activity levels of a user's body parts in accordance with an embodiment of the present invention.

FIG. 3A is a schematic diagram illustrating a ring device that can be configured to measure nerve activity levels of a user's body parts in accordance with an embodiment of the present invention.

FIG. 3B is a schematic diagram illustrating use of the ring device of FIG. 3A in conjunction with a hand-held device.

FIG. 4 is a schematic diagram illustrating a system for controlling a computer program running on an electronic device using nerve analysis according to an embodiment of the present invention.

FIG. 5 illustrates a block diagram of a computer apparatus that may be used to implement a method for controlling an electronic device using nerve analysis according to an embodiment of the present invention.

FIG. 6 illustrates an example of a non-transitory computer readable storage medium in accordance with an embodiment of the present invention.

### DESCRIPTION OF THE SPECIFIC EMBODIMENTS

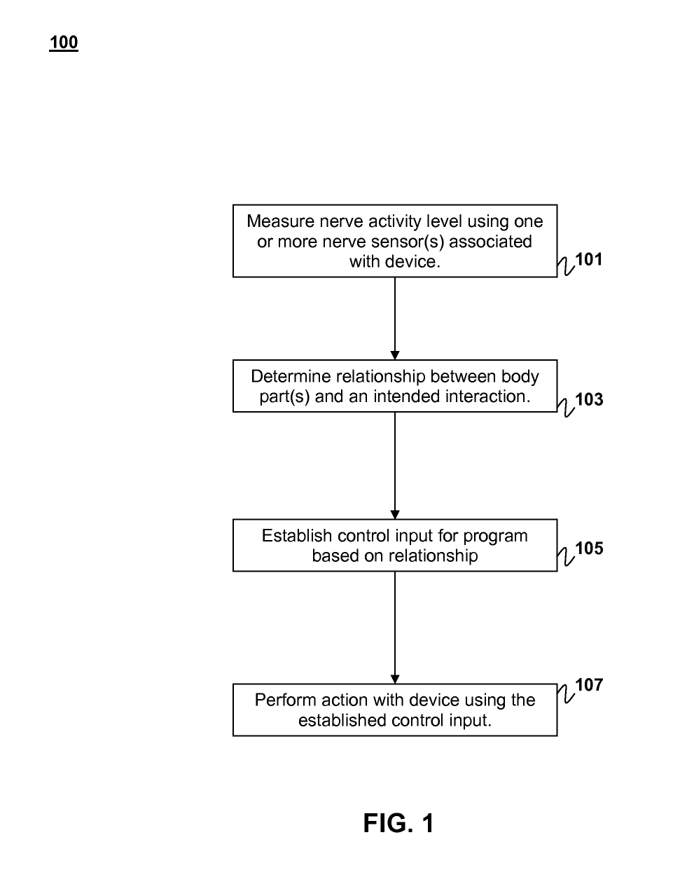

FIG. 1 is a flow diagram illustrating a method for controlling a computer program running on an electronic device using nerve analysis according to an embodiment of the present invention. The first step involves measuring a nerve activity level for one or more body parts of a user of the computer program using one or more nerve sensors associated with the electronic device as indicated at 101. Depending on the application, these nerve sensors may be positioned in various positions on various components of the electronic device to facilitate measurement of nerve activity level of different body parts of the user. By way of example, and not by way of limitation, a user may communicate with a video game system using a controller that includes nerve sensors positioned to measure nerve activity of one or more of the user's fingers during game play. Alternative configurations for nerve sensors will be described in greater detail below. As used herein, the term component refers to any interface component (e.g., controller, camera, microphone, etc.) associated with the electronic device, including the actual device itself.

Once nerve activity levels have been determined for a given user's body parts, a relationship is determined between the user's measured body parts and an intended interaction by the user with one or more components of the electronic device as indicated at 103. By way of example, and not by way of limitation, the nerve activity level of a user's fingers may be used to determine the position/acceleration of a user's finger with respect to the video game controller. This relationship may correspond to the user's intent when interacting with the electronic device (e.g., intent to push a button on the game controller). Additional sensors may be used to provide supplemental information to help facilitate determination of a relationship between the user's body parts and the components of the electronic device. By way of example, and not by way of limitation, cameras associated with the electronic device may be configured to track the user's eye gaze direction in order to determine whether or not a user intended to push a button on the game controller. Nerve sensors can independently determine the relationship between a user's body and a component of a electronic device by allowing user to configure the device, e.g., through a menu.

Once a relationship has been determined, a control input may be established based on the relationship between the user's body parts and the components of the electronic device as indicated at 105. By way of example, and not by limitation, the control input may direct the computer program to perform an action in response to the pushing of a button based the proximity of the user's finger to the game controller and the acceleration with which the user's finger is moving towards the game controller. At some acceleration and proximity, the user cannot avoid pushing the button. Also, an increase in nerve activity level may signal the computer program to zoom in on a particular region of an image presented on a display, such as a character, an object, etc., that is interest of the user. Alternatively, the control input may direct the computer program to perform no action because the proximity of the user's finger to the game controller and the acceleration with which the user's finger is moving towards the game controller falls below a threshold.

In some embodiments, the control input may contain a set of actions that are likely to be executed by the user with their likelihood probability scores. In many computer program applications, the number of possible actions that are likely to be executed can be quite large. A reduced set of possible actions can be determined by a computer program based on the measured nerve activity, eye gaze direction, and the location of fingers, etc. Then, with additional evidence from the computer software/application, content etc., a final decision can be made regarding which possible action to execute. This might both improve estimated input accuracy and make the system faster.

In some embodiments, pre-touch/pre-press activity could be detected by nerve signal analysis and used to reduce latency for real-time network applications, such as online games. For example, if a particular combination of nerve signals can be reliably correlated to a specific user activity, such as pressing a specific button on a controller, it may be possible to detect that a user is about to perform the specific activity, e.g., press the specific button. If the pressing of the button can be detected one millisecond before the button is actually pressed, network packets that would normally be triggered by the pressing of the button can be sent one millisecond sooner. This can reduce the latency in multi-user network applications by that amount. This could dramatically improve the user experience for time critical network applications, such as real time online combat-based games played over a network.

Finally, the computer program may perform an action using the control input established as indicated at 107. By way of example, and not by way of limitation, this action may be an action of a character/object in the computer program being controlled by the user of the device.

The measured nerve activity levels, the established relationships between user body parts and components of the electronic device, and the determined control inputs may be fed back into the system to enhance performance. Currently measured nerve activity levels may be compared to previously measured nerve activity levels in order to ensure the establishment of more accurate relationships and control inputs.

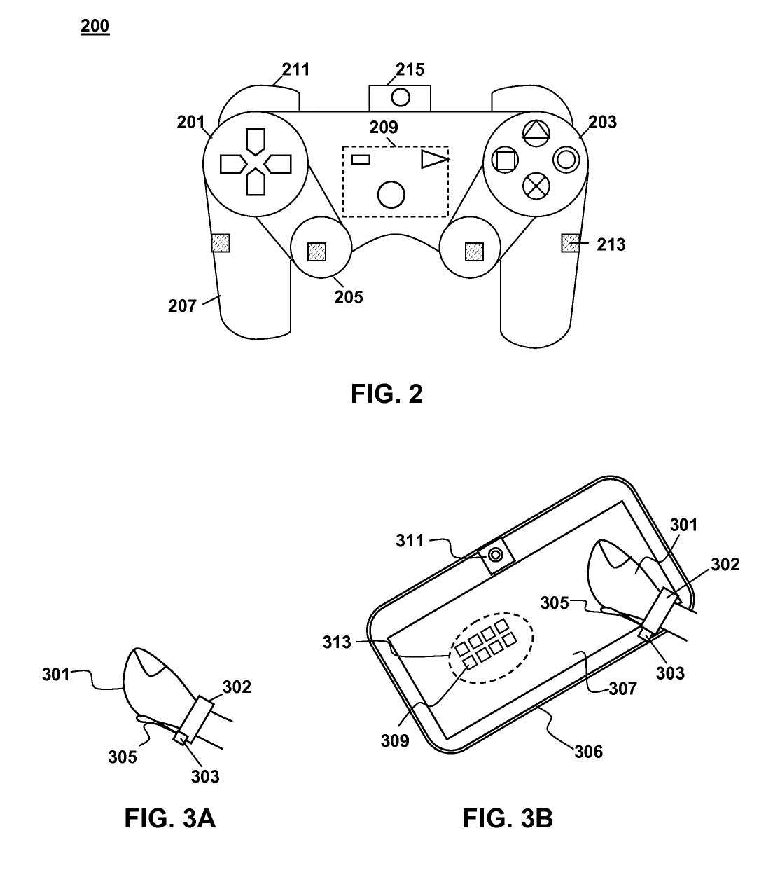

FIG. 2 illustrates a component of an electronic device configured to measure nerve activity levels of a user's body parts in accordance with an embodiment of the present invention. For purposes of example, and not of limitation, the component of the electronic device may be a game controller 200. However, the component of the electronic device configured to measure nerve activity levels may be any interface device including a mouse, keyboard, joystick, steering wheel, or other interface device. Furthermore, nerve sensors may be included on the case of a hand-held computing device such as a tablet computer or smartphone. As such, embodiments of the present invention are not limited to implementations involving game controllers or similar interface devices.

The game controller 200 may include a directional pad 201 for directional user input, two analog joysticks 205 for directional user input, buttons 203 for button-controlled user input, handles 207 for holding the device 200, a second set of buttons 209 for additional button-controlled user input, and one or more triggers 211 for trigger-controlled user input. By way of example, and not by way of limitation, the user may hold the device by wrapping his palms around the handles 207 while controlling joysticks 205, directional pad 201, and control buttons 203 with his thumbs. The user may control the triggers 211 using his index fingers.

Nerve sensors 213 may be placed around the game controller 200 in order to measure nerve activity levels for certain body parts of a user as he is operating a computer program running on the electronic device. In FIG. 2, two nerve sensors 213 are located on the joysticks 205, and two nerve sensors are located on the handles 213. The nerve sensors 213 on the joysticks 205 may be used to measure the nerve activity level of the user's thumbs as he is operating the controller 200. The nerve sensors 213 on the handles 207 may be used to measure the nerve activity level of the user's palms as he is operating the controller 200. The nerve activity levels determined may then be used to determine a relationship between the user's measured body parts and the controller 200. By way of example, and not by way of limitation, the nerve sensors 213 on the joysticks 205 may be used to determine the user's thumb position in relation to the joystick 205, the acceleration of the user's thumb as it moves toward the joystick 205, and whether the user's thumb is in direct physical contact with the joystick 205. Similarly, the nerve sensors 213 on the handles 207 may be used to determine the force with which the user's palms are gripping the controller 200.

While only four nerve sensors 213 are illustrated in FIG. 2, it is important to note that any number of nerve sensors may be placed in any number of locations around the controller 200 to facilitate measurement of nerve activity level based on the application involved. Additional nerve sensors may be placed on the directional pad 201, buttons 203, 209, or triggers 211 to measure nerve activity level of different user body parts.

The controller 200 may additionally include a camera 215 to help facilitate determination of a relationship between the user's body parts and the controller 200. The camera 215 may be configured to track the position of the fingers with respect to the controller 215 or the acceleration of the fingers. The camera provides supplemental data used to help more accurately determine the relationship between the user's body parts and the components of the device.

FIG. 3A illustrates an alternative component of an electronic device that can be configured to measure nerve activity levels of a user's body parts in accordance with an embodiment of the present invention. FIG. 3A illustrates a wireless stress sensor 303 configured to be positioned around the ring 302 which can be placed on a user's finger 301. The wireless stress sensor 303 measures nerve activity levels of the finger 301 during operation of the computer program by correlating electrical resistance induced by the finger to a nerve activity level. The wireless stress sensor 303 may interact with the controller to help determine a relationship between the finger and the controller (e.g., through a magnetic force generated between the stress sensor and the buttons of the controller). By way of example, and not by way of limitation, this relationship may indicate the distance between the user's finger and the controller, or the acceleration of the finger as it nears the controller.

The wireless stress sensor 303 may additionally include a spring element 305, which may activate the stress sensor when the user's finger flexes. Alternatively, the spring element 305 may include built-in stress sensors that measure deflection of the spring element. When the spring element 305 flexes due to pressure exerted by the user's finger 301 the pressure sensors generate a sensor signal in proportion to the pressure exerted. The pressure sensor signal can be used to estimate fine muscle movement of the finger 301 as a proxy for nerve activity level. This spring 305 may also provide supplemental information (e.g., force with which finger is pushing a button on the controller) to facilitate determination of a relationship between the user's finger and the controller.

It is noted that embodiments of the present invention include implementations that utilize ‘wearable’ nerve sensing devices located on wearable articles other than the ring-based sensor depicted in FIG. 3A. Some other non-limiting examples of wearable nerve sensing devices include nerve sensors that are incorporated into wearable articles such gloves or wrist bands or necklace or Bluetooth headset or a medical patch. Such wearable nerve sensing devices can be used to provide information to determine if a user is interacting with a virtual user interface that may only be visible to the user, but does not physically exist. For example, a user could interact with projected or augmented virtual user interfaces by using these wearable nerve sensors to determine when a user is pressing a virtual button or guiding a virtual cursor.

FIG. 3B illustrates an example in which the ring of FIG. 3A is used in conjunction with a hand-held device 306 having a touch interface 307. The device can be a portable game device, portable internet device, cellular telephone, personal digital assistant or similar device. The touch interface 307 can be a touch pad, which acts as an input device. Alternatively, the touch interface 307 may be a touch screen, which also acts as both a visual display and an input device. In either case, the touch interface includes a plurality of individual touch sensors 309 that respond to the pressure or presence of the user's touch on the interface. The size of the sensors 309 and spacing between the sensors determines the resolution of the touch interface.

Generally, the user must touch the interface 307 in order to enter a command or perform an action with the device. It can be useful to determine whether the user intended to touch a particular area of the interface in order to avoid interpreting a touch as a command when this is not what was intended. The ability to determine the intent of the user's touch is sometimes referred to as “pre-touch”.

By using a built-in pressure sensor in the ring 302 or by measuring the electric resistance, one can estimate the fine muscle movement of the finger to estimate the nerve activity. By using the nerve activity, the onset of the burst of the nerve activity, one can estimate a pre-touch action.

By detecting the nerve or muscle activities at different location of the muscle of one or multiple fingers or arms, one can implement fine control of the touch interface 307. By way of example and not by way of limitation, the device 306 may include a camera that looks back at the user's face to track the user's eye gaze, e.g., using images from a camera 311 that faces the user. Alternatively, gaze may be tracked using an infrared source that projects infrared light towards the user in conjunction with a position sensitive optical detector (PSD). Infrared light from the source may retroreflect from the retinas of the user's eyes to the PSD. By monitoring the PSD signal it is possible to determine the orientation of the user's eyes and thereby determine eye gaze direction.

Tracking the user's eye gaze can be used to enhance manipulation of objects displayed on a touch screen. For example, by tracking the user's eye gaze, the device 306 can locate and select an object 313 displayed on a display screen. Thumb and index finger nerve activity can be detected and converted to signals used to rotate the object that has been chosen by eye gaze. In addition, the user's eye gaze can be used to increase the resolution of a particular region of the hand-held device's screen; e.g., by triggering the display to zoom-in on the object 313 if the user's gaze falls on it for some predetermined period of time. It is also noted that gaze tracking can be applied to projected or augmented virtual user interfaces, where a combination of gaze tracking and nerve analysis can be used to determine user interaction with virtual objects.

Alternatively, the camera 311 could look at the touch screen so that images of the user's finger can be analyzed to determine acceleration of the fingers and figure out what button is going to be pressed or which one is being pressed. At some value of acceleration of the finger and proximity of the finger to the button the user cannot avoid pressing the button. Also, from the location of the finger and measured nerve activity, it is possible to estimate a region on the display that is of interest to the user. Through suitable programming, the device 306 can increase the resolution and/or magnification of such a region of interest to assist to the user. In addition, the user's eye gaze direction, the measured nerve activity and the location of fingers all can be combined to estimate the user's intention or region of interest and the resolution of the sub-parts of the screen can be adapted accordingly.

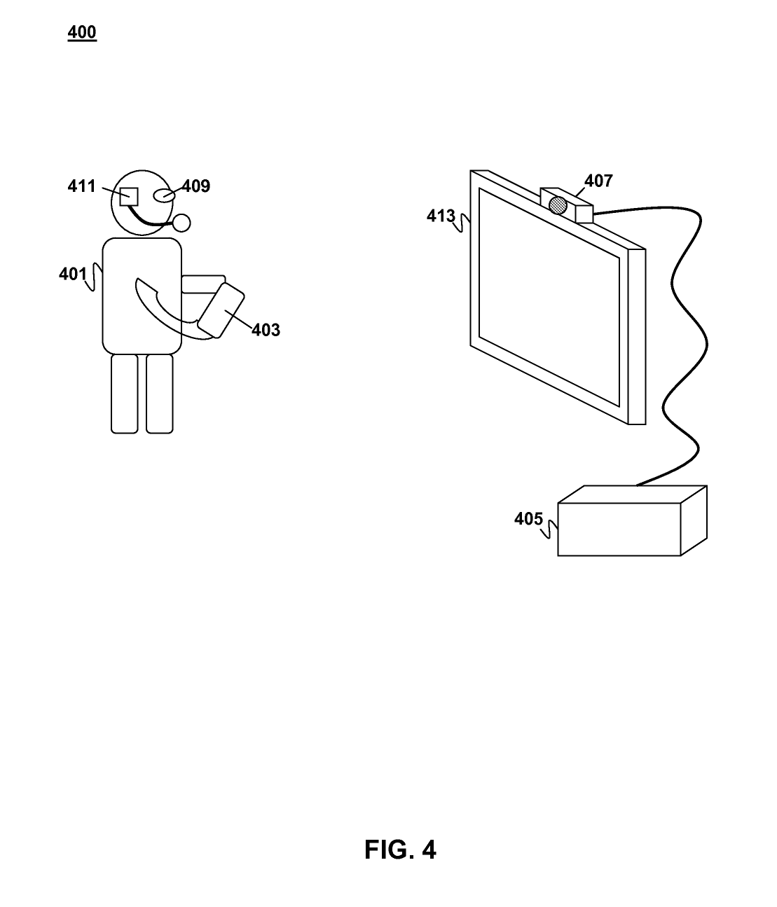

There are a number of different possible configurations for a device that incorporates embodiments of the present invention. By way of example, and not by way of limitation, FIG. 4 shows a schematic diagram illustrating a system 400 for controlling a computer program running on an electronic device using nerve analysis according to an embodiment of the present invention. A user 401 may interact with a computer program running on an electronic device 405. By way of example, and not by way of limitation, the electronic device 405 may be a video game console. The computer program running on the electronic device 405 may be a video game, wherein the user controls one or more characters/objects in a game environment. The video game console 405 may be operably connected to a visual display 413, configured to display the gaming environment to the user. The user may then control certain aspects of the video through a controller (i.e., device component) 403 that communicates with the electronic device 405. The device controller may be configured to measure nerve level activity of the user 401 as discussed above with respect to FIGS. 2, 3A, and 3B.

Once nerve level activity has been measured, a relationship between the user's body parts and the components of the electronic device must be determined. As discussed above, the controller may be configured to determine the position/acceleration of the user's fingers with respect to the controller 403. However, additional relationships (i.e., user orientation characteristics) may also be established using other components associated with electronic device, such that the control input established may be more accurate. One user orientation characteristic that may be established is the user's eye gaze direction. The user's eye gaze direction refers to the direction in which the user's eyes point during interaction with the program. In many situations, a user may make eye contact with a visual display in a predictable manner during interaction with the program. This is quite common, for example, in the case of video games. In such situations tracking the user's eye gaze direction can help establish a more accurate control input for controlling the video game. One way to obtain a user's eye gaze direction involves a pair of glasses 409 and a camera 407. The glasses 409 may include infrared light sensors. The camera 407 is then configured to capture the infrared light paths emanating from the glasses 409 and then triangulate the user's eye gaze direction from the information obtained. Although, technically, this configuration primarily provides information about the user's head pose, if the position of the glasses 409 does not vary significantly with respect to its position on the user's face and because the user's face will usually move in accordance with his eye gaze direction, this setup can provide a good estimation of the user's eye gaze direction. For more detailed eye-gaze tracking it is possible to determine the location of the pupils of the eyes relative to the sclera (white part) of the eyes. An example of how such tracking may be implemented is described, e.g., in “An Algorithm for Real-time Stereo Vision Implementation of Head Pose and Gaze Direction Measurement”, by Yoshio Matsumoto and Alexander Zelinsky in FG '00 Proceedings of the Fourth IEEE International Conference on Automatic Face and Gesture Recognition, 2000, pp 499-505, the entire contents of which are incorporated herein by reference.

Alternatively, the user's eye gaze direction may be obtained using a headset 411 with infrared sensors. The headset may be configured to facilitate interaction between the user and the computer program on the visual display 413. Much like the configuration of the glasses, the camera 407 may capture infrared light emanating from the headset 411 and then triangulate the user's head tilt angle from the information obtained. If the position of the headset 411 does not vary significantly with respect to its position on the user's face, and if the user's face generally moves in accordance with his eye gaze direction, this setup will provide a good estimation of the user's eye gaze direction.

It is important to note that various user orientation characteristics in addition to eye gaze direction may be combined with nerve analysis to establish a control input for the computer program.

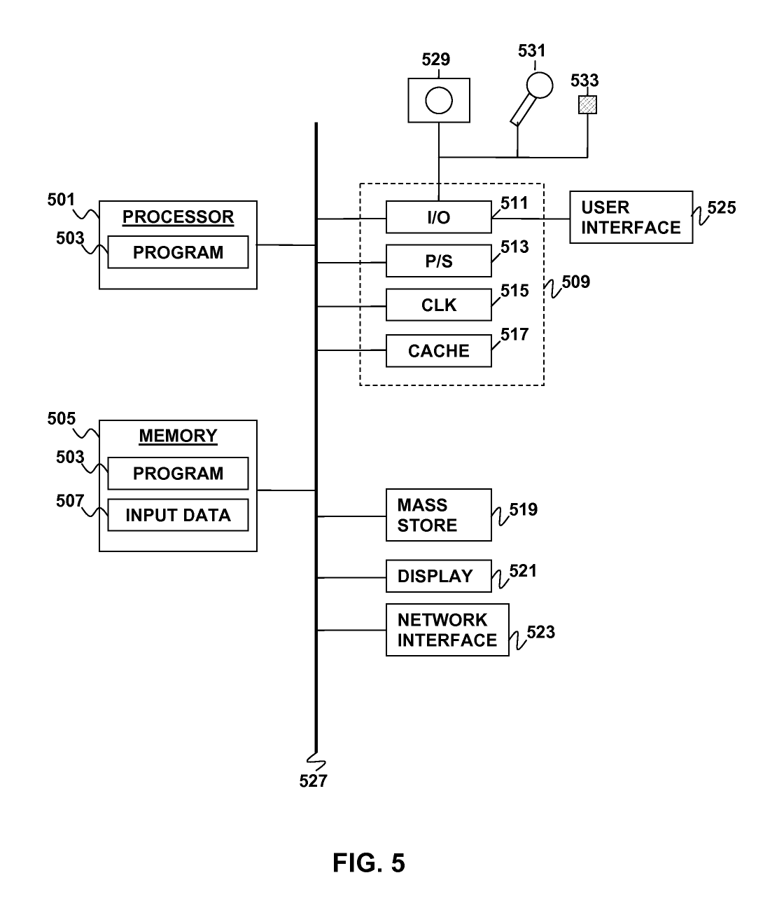

FIG. 5 illustrates a block diagram of a computer apparatus that may be used to implement a method for controlling an electronic device using nerve analysis according to an embodiment of the present invention. The apparatus 500 generally may include a processor module 501 and a memory 505. The processor module 501 may include one or more processor cores. An example of a processing system that uses multiple processor modules, is a Cell Processor, examples of which are described in detail, e.g., in Cell Broadband Engine Architecture, which is available online at http://www-306.ibm.com/chips/techlib/techlib.nsf/techdocs/1AEEE1270EA2776387357060006E61BA/$file/CBEA_{—}01_pub.pdf, which is incorporated herein by reference. It is noted that other multi-core processor modules or single core processor modules may be used.

The memory 505 may be in the form of an integrated circuit, e.g., RAM, DRAM, ROM, and the like. The memory 505 may also be a main memory that is accessible by all of the processor modules. In some embodiments, the processor module 501 may have local memories associated with each core. A program 503 may be stored in the main memory 505 in the form of processor readable instructions that can be executed on the processor modules. The program 503 may be configured to control the device 500 using nerve analysis. The program 503 may be written in any suitable processor readable language, e.g., C, C++, JAVA, Assembly, MATLAB, FORTRAN, and a number of other languages. Input data 507 may also be stored in the memory. Such input data 507 may include measured nerve activity levels, determined relationships between a user's body parts and the electronic device, and control inputs. During execution of the program 503, portions of program code and/or data may be loaded into the memory or the local stores of processor cores for parallel processing by multiple processor cores.

It is noted that embodiments of the present invention are not limited to implementations in which the device is controlled by a program stored in memory. In alternative embodiments, an equivalent function may be achieved where the processor module 501 includes an application specific integrated circuit (ASIC) that receives the nerve activity signals and acts in response to nerve activity.

The apparatus 500 may also include well-known support functions 509, such as input/output (I/O) elements 511, power supplies (P/S) 513, a clock (CLK) 515, and a cache 517. The apparatus 500 may optionally include a mass storage device 519 such as a disk drive, CD-ROM drive, tape drive, or the like to store programs and/or data. The device 500 may optionally include a display unit 521 and user interface unit 525 to facilitate interaction between the apparatus 500 and a user. The display unit 521 may be in the form of a cathode ray tube (CRT) or flat panel screen that displays text, numerals, graphical symbols, or images. The user interface 525 may include a keyboard, mouse, joystick, light pen, or other device that may be used in conjunction with a graphical user interface (GUI). The apparatus 500 may also include a network interface 523 to enable the device to communicate with other devices over a network, such as the internet.

One or more nerve sensors 533 may be connected to the processor module 501 via the I/O elements 511 via wired or wireless connections. As mentioned above, these nerve sensors 533 may be configured to detect nerve activity level of a body part of the user of the device 500 in order to facilitate control of the device 500.

In some embodiments, the system may include an optional camera 529. The camera 529 may be connected to the processor module 501 via the I/O elements 511. As mentioned above, the camera 529 may be configured to track certain orientation characteristics of the user of the device 500 in order to supplement the nerve analysis.

In some other embodiments, the system may also include an optional microphone 531, which may be a single microphone or a microphone array. The microphone 531 can be coupled to the processor 501 via the I/O elements 511. As discussed above, the microphone 531 may be configured to track certain orientation characteristics of the user of the device 500 in order to supplement the nerve analysis.

The components of the system 500, including the processor 501, memory 505, support functions 509, mass storage device 519, user interface 525, network interface 523, and display 521 may be operably connected to each other via one or more data buses 527. These components may be implemented in hardware, software, firmware, or some combination of two or more of these.

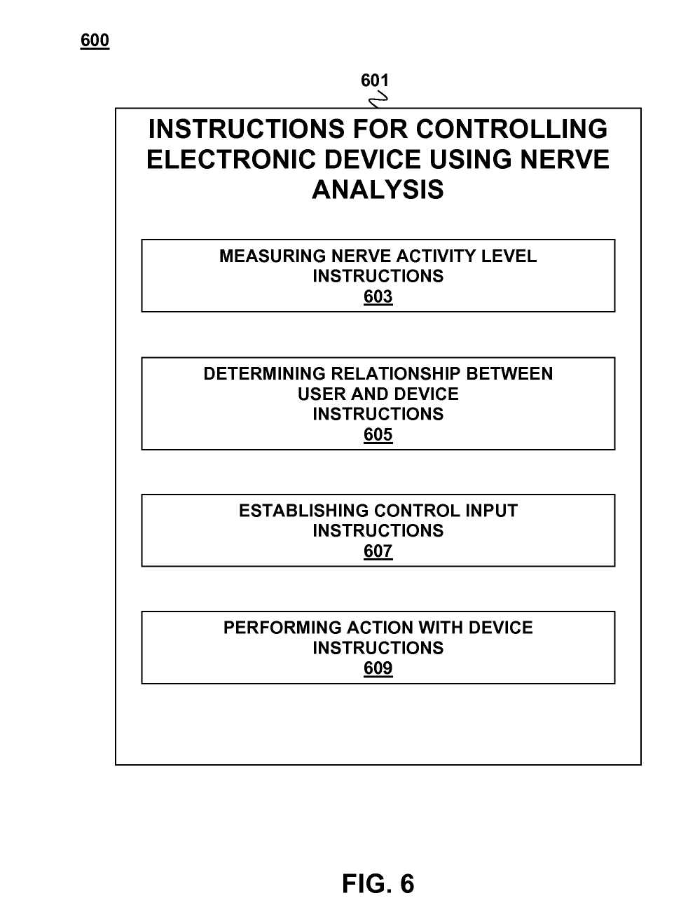

According to another embodiment, instructions for controlling a device using nerve analysis may be stored in a computer readable storage medium. By way of example, and not by way of limitation, FIG. 6 illustrates an example of a non-transitory computer readable storage medium 600 in accordance with an embodiment of the present invention. The storage medium 600 contains computer-readable instructions stored in a format that can be retrieved, interpreted, and executed by a computer processing device. By way of example, and not by way of limitation, the computer-readable storage medium 600 may be a computer-readable memory, such as random access memory (RAM) or read only memory (ROM), a computer readable storage disk for a fixed disk drive (e.g., a hard disk drive), or a removable disk drive. In addition, the computer-readable storage medium 600 may be a flash memory device, a computer-readable tape, a CD-ROM, a DVD-ROM, a Blu-Ray, HD-DVD, UMD, or other optical storage medium.

The storage medium 600 contains instructions for controlling an electronic device using nerve analysis 601 configured to control aspects of the electronic device using nerve analysis of the user. The controlling electronic device using nerve analysis instructions 601 may be configured to implement control of an electronic device using nerve analysis in accordance with the method described above with respect to FIG. 1. In particular, the controlling electronic device using nerve analysis instructions 601 may include measuring nerve level activity instructions 603 that are used to measure nerve level activity of body parts of a user using the device. The measurement of nerve level activity may be performed using any of the implementations discussed above.

The controlling electronic device using nerve analysis instructions 601 may also include determining relationship between user and device instructions 605 that are used to determine a relationship between a user's measured body parts and the device. This relationship may encompass the speed at which a user's body part is travelling relative to the device, the direction at which a user's body part is travelling relative to the device, or the position of the user's body part relative to the device as discussed above.

The controlling electronic device using nerve analysis instructions 601 may further include establishing control input instructions 607 that are used to establish a control input for the device based on the relationship established between the user's measured body parts and the device. The control input may instruct the device to perform an action or stay idle or may be used by the device to determine a set of actions that are likely to be executed, as discussed above.

The controlling electronic device using nerve analysis instructions 601 may further include performing action with device instructions 609 that are used to perform an action with the device in accordance with the control input established through nerve analysis. Such actions may include those actions discussed above with respect to FIG. 1.

While the above is a complete description of the preferred embodiment of the present invention, it is possible to use various alternatives, modifications, and equivalents. Therefore, the scope of the present invention should be determined not with reference to the above description, but should, instead, be determined with reference to the appended claims, along with their full scope of equivalents. Any feature described herein, whether preferred or not, may be combined with any other feature described herein, whether preferred or not. In the claims that follow, the indefinite article “A” or “An” refers to a quantity of one or more of the item following the article, except where expressly stated otherwise. The appended claims are not to be interpreted as including means-plus-function limitations, unless such a limitation is explicitly received in a given claim using the phrase “means for”.

What is claimed is:

1. A method for controlling an electronic device using nerve analysis, comprising:
a) measuring a nerve activity level for one or more body parts of a user of the device using one or more nerve sensors associated with the electronic device;
b) determining a relationship between the user's one or more body parts and an intended interaction by the user with one or more components of the electronic device using each nerve activity level determined in a); and
c) establishing a control input or reduced set of likely actions for the electronic device based on the relationship determined in b).

2. The method of claim 1, wherein the one or more nerve sensors in a) are located on one or more components of the electronic device.

3. The method of claim 2, wherein the one or more components of the electronic device are located on the user.

4. The method of claim 3, wherein the one or more components of the electronic device located on the user include a wireless stress sensor located on an article configured to be worn by the user.

5. The method of claim 4, wherein the wireless stress sensor includes a pressure sensor.

6. The method of claim 1, wherein determining a relationship between the user's one or more body parts and the intended interaction in b) further includes using one or more orientation characteristics of the user.

7. The method of claim 6, wherein the one or more orientation characteristics includes the user's head orientation and eye gaze direction.

8. The method of claim 1, wherein establishing a control input for the electronic device in c) further includes using a history of the user's past nerve activity associated with use of the electronic device.

9. The method of claim 1, further comprising performing an action with the electronic device using the control input established in c).

10. The method of claim 1, wherein c) includes establishing a reduced set of likely actions for the electronic device based on the relationship determined in b), receiving additional information, and executing a final decision from the reduced set of likely actions based on the additional information.

11. The method of claim 1, wherein b) includes correlating a nerve activity level for one or more body parts of the user to a specific user activity to detect that the user is about to perform the specific activity, and taking an action with the device before that action would normally be triggered by the specific activity.

12. An electronic device, comprising:
one or more nerve sensors;
a processor operably coupled to the one or more nerve sensors; and
instructions executable by the processor configured to:
a) measure a nerve activity level for one or more body parts of a user of a computer program of the electronic device using the one or more nerve sensors;
b) determine a relationship between the user's one or more body parts and an intended interaction by the user with one or more components of the electronic device using each nerve activity level determined in a); and
c) establish a control input or reduced set of likely actions for the electronic device based on the relationship determined in b).

13. The device of claim 12, wherein the one or more nerve sensors in a) are located on one or more components of the electronic device.

14. The device of claim 13, wherein the one or more components of the electronic device are configured to be located on the user.

15. The device of claim 14, wherein the one or more components of the electronic device include a wireless stress sensor located on a ring configured to fit a finger of the user.

16. The device of claim 15, wherein the wireless stress sensor includes a pressure sensor.

17. The device of claim 12, wherein determining the relationship between the user's one or more body parts and the intended interaction by the user with one or more components of the electronic device uses one or more orientation characteristics of the user.

18. The device of claim 17, wherein the one or more orientation characteristics includes the user's head orientation and eye gaze direction.

19. The device of claim 12, wherein establishing a control input for the electronic device includes using a history of the user's past nerve activity associated with use of the electronic device.

20. The device of claim 12, wherein the processor is configured to establish a reduced set of likely actions, based on the relationship determined in b), receive additional information, and execute a final decision from the reduced set of likely actions based on the additional information.

21. The device of claim 12, wherein the processor is configured to correlate a nerve activity level for one or more body parts of the user to a specific user activity to detect that the user is about to perform the specific activity, and take an action with the device before that action would normally be triggered by the specific activity.

22. A computer program product, comprising:
a non-transitory computer-readable storage medium having computer readable program code embodied in said medium for controlling a computer program running on an electronic device using nerve analysis, said computer product having:
a) computer readable program code means for measuring a nerve activity level for one or more body parts of a user of the computer program using one or more nerve sensors associated with the electronic device;
b) computer readable program code means for determining a relationship between the user's one or more body parts and an intended interaction by the user with one or more components of the electronic device using each nerve activity level determined in a); and
c) computer readable program code means for establishing a control input for the computer program based on the relationship determined in b).
